(19) United States
(12) Patent Application Publication
(10) Pub. No.: US 2025/0389303 A1
(43) Pub. Date: Dec. 25, 2025

(54) CLUTCH

(71) Applicant: Christianson Systems, Inc., Blomkest, MN (US)

(72) Inventors: Jim Gerhardt, St. Augusta, MN (US); Shannon Hansen, St. Cloud, MN (US); Daniel Orellana, St. Cloud, MN (US)

(73) Assignee: Christianson Systems, Inc., Blomkest, MN (US)

(21) Appl. No.: 18/879,923

(22) PCT Filed: Jun. 27, 2023
(86) PCT No.: PCT/US2023/069178

§ 371 Date: Dec. 30, 2024

Related U.S. Application Data
(60) Provisional application No. 63/357,149, filed on Jun. 30, 2022.

(51) Int. Cl. F16D 41/06; F16D 41/28

(52) U.S. Cl. CPC F16D 41/06; F16D 41/28; F16D 2041/0603

(57) ABSTRACT

A clutch with an inner rotatable member and an outer rotatable member. A plurality of clutch members are arranged between the inner rotatable member and the outer rotatable member to permit relative rotation of the inner rotatable member with respect to the outer rotatable member in a first direction and restrict relative rotation of the inner rotatable member with respect to the outer rotatable member in a second direction. The clutch members include a wedge portion and an interlocking portion. The wedge portion and the interlocking portion engage with the inner rotatable member and the outer rotatable member to restrict the rotation in the second direction. The wedge portion engages before the interlocking portion.

This application is being filed on Jun. 27, 2023, as a PCT International Patent application and claims the benefit of and priority to U.S. Provisional patent application Ser. No. 63/357,149, filed Jun. 30, 2022, the entire disclosure of which is incorporated by reference herein in its entirety.

### BACKGROUND

Clutch assemblies are generally used to connect and disconnect two rotating shafts. In some applications, a drive shaft is connected to a power source and a driven shaft is selectively connected to the first shaft to transmit the power from the power source to drive a vehicle or piece of machinery. Clutch assemblies can be engaged, in which case the shafts are locked together to rotate at the same speed, or disengaged, in which case the shafts are not locked together and rotate at different speeds.

Freewheel clutches engage and allow for a drive shaft to rotate the driven shaft when the drive shaft rotates faster than the driven shaft. Freewheel clutches disengage when the driven shaft rotates faster than the drive shaft. Freewheel clutches have applications in agricultural equipment, engine starters, vehicle transmissions, bicycles, and helicopters. Freewheel clutches may take various forms and include, for example, ratcheting freewheels, sprag clutches, and slipper clutches.

Freewheeling bicycle hubs are generally known. For example, U.S. Pat. No. 2,211,548 to Frank W. Schwinn issued on Jun. 24, 1940 is directed to a freewheeling bicycle hub configuration. Freewheeling bicycle hubs are configured to enable rotation of the pedals to drive the rotation of the wheels while also allowing the wheels to rotate independent of the rotation of the pedals. This functionality enables the pedals of the bike to be held stationary while the wheels rotate as the bike coasts. Freewheeling bicycle hubs are also commonly referred to as coaster hubs.

Different mechanisms have been used to provide freewheeling bicycle hubs. For example, some freewheeling bicycle hubs utilize pawls to drive the rotation of the bicycle hub. Other freewheeling bicycle hubs utilize sprags. For example, U.S. Pat. No. 9,102,197 to Gerhardt et al., the disclosure of which is hereby incorporated by reference, discloses a freewheeling bicycle hub that uses a sprag type clutch configuration to drive the rotation of the bicycle hub.

### SUMMARY

In general terms, this disclosure is directed to a clutch. In some embodiments, and by non-limiting example, the clutch includes an inner rotating member and an outer rotating member configured to rotate with respect to each other in a first direction. A plurality of clutch members are arranged between the inner rotating member and the outer rotating member. In some embodiments, the clutch members include both a wedge portion and an interlocking portion, both of which engage with the inner rotating member and the outer rotating member to restrict the relative rotation between the inner and outer rotating member in the second direction.

One aspect of the present disclosure is a clutch. The clutch comprises inner and outer rotatable members configured to rotate about an axis of rotation. The inner rotatable member is positioned radially inside the outer rotatable member. The clutch further comprises a plurality of clutch members positioned radially between the inner and outer rotatable members. The clutch members are spaced circumferentially about the axis of rotation relative to one another. The clutch members each include a wedge portion and an interlock portion. When relative rotation between the inner and outer rotatable members is forced in a second rotational direction the clutch members move to an engaged state in which the clutch members prevent relative rotation between the inner and outer rotatable members causing the inner and outer rotatable members to rotate in unison with one another about the axis of rotation. When relative rotation between the inner and outer rotatable members is forced in a first rotational direction the clutch members move to a disengaged state in which the clutch members allow relative rotation between the inner and outer rotatable members. Engagement of the clutch members is sequenced such that the wedge portions engage prior to the interlock portions as the clutch members move from the disengaged state to the engaged state.

Another aspect of the present disclosure is a clutch assembly. The clutch assembly comprises an inner rotatable member and an outer rotatable member having a portion being concentric with the inner rotatable member. The clutch assembly further comprises a plurality of clutch members including a wedge portion and an interlocking portion. The plurality of clutch members is arranged between the inner rotatable member and the outer rotatable member. The inner rotatable member and the outer rotatable member are freely rotatable when rotated with respect to one another in a first direction. The inner rotatable member and the outer rotatable member are coupled to one another by the clutch members to restrict the rotation of the inner rotatable member and the outer rotatable member with respect to one another in a second direction. The interlocking portion of the clutch members is configured to contact a featured clutch contacting portion on at least one of the inner and outer rotatable members. The wedge portion of the clutch members being configured to contact a smooth clutch contacting portion on at least one of the inner and outer rotatable members. The smooth clutch contacting portion is smooth relative to the featured clutch contacting portion

### BRIEF DESCRIPTION OF THE DRAWINGS

FIG. 1 is a cross sectional side view of an example clutch assembly with clutch members arranged in a first orientation.

FIG. 2 is a cross sectional side view of the example clutch assembly of FIG. 1 with the clutch members arranged in a second orientation.

FIG. 3 is a cross sectional side view of the example clutch assembly of FIG. 1 with the clutch members arranged in a third orientation.

FIG. 4 is a perspective view of a bicycle wheel including an example hub.

FIG. 5 is a perspective view of the hub shown in FIG. 4.

FIG. 6 is a cross sectional view of the example hub of FIG. 5.

FIG. 7 is an exploded view of the example hub of FIG. 5.

FIG. 8 is an exploded view of an example inner sleeve assembly and freehub of the example hub of FIG. 5.

FIG. 9 is a perspective view of an example outer sleeve assembly of the hub of FIG. 6.

FIG. 10 is an example perspective view of an example clutch frame assembly of the hub of FIG. 6.

FIG. 11 is a perspective view of an example clutch member of the example clutch frame assembly of FIG. 10.

FIG. 12 is another perspective view of the clutch member of FIG. 11.

FIG. 13 is a front view of the clutch member of FIG. 11.

FIG. 14 is a cross sectional side view of the example clutch member of FIG. 11 along line 14, showing an example wedge portion.

FIG. 15 is a cross sectional side view of the example clutch member of FIG. 11 along line 15, showing an example transition portion.

FIG. 16 is a cross sectional side view of the example clutch member of FIG. 11 along line 16, showing an example interlocking portion.

FIG. 17 is a cross sectional side view of the example hub of FIG. 6 along line 17, showing the wedge portion of the clutch members in a first orientation.

FIG. 18 is a detail view of the cross sectional side view of FIG. 17.

FIG. 19 is a cross sectional side view of the example hub of FIG. 6 along line 19, showing the interlocking portion of the clutch members in a first orientation.

FIG. 20 is a detail view of the cross sectional side view of FIG. 19.

FIG. 21 is a cross sectional side view of the example hub of FIG. 6 along line 17, showing the wedge portion of the clutch members in a second orientation.

FIG. 22 is a detail view of the cross sectional side view of FIG. 21.

FIG. 23 is a cross sectional side view of the example hub of FIG. 6 along line 19, showing the interlocking portion of the clutch members in the second orientation.

FIG. 24 is a detail view of the cross sectional view of FIG. 23.

FIG. 25 is a cross sectional side view of the example hub of FIG. 6 along line 17, showing the wedge portion of the clutch members in a third orientation.

FIG. 26 is a detail view of the cross sectional view of FIG. 23.

FIG. 27 is a cross sectional side view of the example hub of FIG. 6 along line 19, showing the interlocking portion of the clutch members in the third orientation.

FIG. 28 is a detail view of the cross sectional view of FIG. 27

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

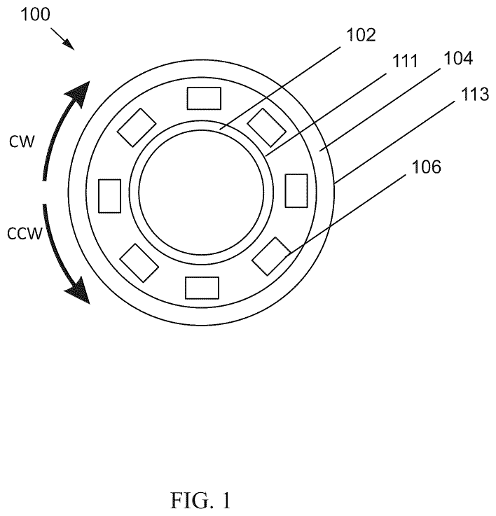

FIG. 1 is a cross sectional side view of an example clutch assembly 100 in accordance with the present invention. The clutch assembly 100 includes an inner rotatable member 102, an outer rotatable member 104, and one or more clutch members 106. The clutch members 106 are generally arranged between the inner rotatable member 102 and the outer rotatable member 104. In some examples, the inner rotatable member 102 and the outer rotatable member 104 are able to be rotated with respect to one another in a first direction.

The respective rotation in the first direction may occur, for example, if the outer rotatable member 104 is rotated in the direction CW (clockwise) while the inner rotatable member 102 is rotated in the direction CCW (counter clockwise). The respective rotation in the first direction may also occur, for example, if the outer rotatable member 104 is rotated in the direction CW while the inner rotatable member 102 is held stationary. The respective rotation in the first direction may also occur, for example, if the inner rotatable member 102 is rotated in the direction CCW while the outer rotatable member 104 is held stationary. The respective rotation in the first direction may further occur, for example, if both the outer rotatable member 104 and the inner rotatable member 102 rotate in the direction CW, but the outer rotatable member 104 rotates faster than the inner rotatable member 102. The respective rotation in the first direction may also occur, for example, if both the outer rotatable member 104 and the inner rotatable member 102 rotate in the direction CCW, but the outer rotatable member 104 rotates slower than the inner rotatable member 102.

In some examples, the inner rotatable member 102 and the outer rotatable member 104 are restricted from being able to rotate with respect to one another in a second direction. In some examples, the clutch members 106 restrict the rotation of the inner rotatable member 102 and the outer rotatable member 104 with respect to one another when rotated in a second direction.

The respective rotation in the second direction may occur, for example, if the outer rotatable member 104 is rotated in the direction CCW while the inner rotatable member 102 is rotated in the direction CW. The respective rotation in the second direction may also occur, for example, if the outer rotatable member 104 is rotated in the direction CCW while the inner rotatable member 102 is held stationary. The respective rotation in the second direction may also occur, for example, if the inner rotatable member 102 is rotated in the direction CW while the outer rotatable member 104 is held stationary. The respective rotation in the second direction may further occur, for example, if both the outer rotatable member 104 and the inner rotatable member 102 rotate in the direction CW, but the outer rotatable member 104 rotates slower than the inner rotatable member 102. The respective rotation in the second direction may also occur, for example, if both the outer rotatable member 104 and the inner rotatable member 102 rotate in the direction CCW, but the outer rotatable member 104 rotates faster than the inner rotatable member 102.

The inner rotatable member 102 generally includes an outer wedge bearing surface 111 with a circular cross section. In some examples, the outer wedge bearing surface 111 of the inner rotatable member 102 faces in an outward radial direction and is configured to interface with one or more of the clutch members 106. In some examples, the inner rotatable member is a shaft.

The outer rotatable member 104 generally includes an inner wedge bearing surface 113 with a circular cross section. In some examples, the inner wedge bearing surface 113 of the outer rotatable member 104 faces in an inward radial direction and is configured to interface with one or more of the clutch members 106. In some examples, the outer rotatable member 104 is a shaft.

The clutch members 106 are generally arranged and spaced apart from one another circumferentially around the outer surface of the inner rotatable member 102. In some examples, as depicted in FIG. 1, the clutch members 106 are spaced apart evenly around the outer surface of the inner rotatable member 102, while in other examples, the clutch members 106 are staggered and are spaced unevenly around the outer surface of the inner rotatable member 102. In some examples, the clutch members 106 are individually rotatable. The rotatability of the clutch members is illustrated in FIGS. 1-3.

FIG. 1 illustrates the clutch members in a first orientation. In the example of FIG. 1, the clutch members are oriented as to permit free rotation between the inner rotatable member 102 and the outer rotatable member 104 in a first direction. In some examples, as illustrated in FIG. 1, the clutch members are oriented as to permit the outer rotatable member 104 to move in the first direction with respect to the inner rotatable member 102. In some examples, when in the first orientation, the clutch members 106 do not contact either the inner rotatable member 102 or the outer rotatable member 104. In other examples, when in the first orientation, the clutch members lightly contact the inner rotatable member 102 and/or the outer rotatable member 104.

In some examples, when the outer rotatable member 104 is rotated in a second direction with respect to the inner rotatable member 102, the clutch members are moved into a second orientation. In some examples, the movement of the clutch members 106 into the second orientation is driven by the contact between the clutch members 106 and the inner rotatable member 102 and/or the outer rotatable member 104. In some examples, movement of the clutch members 106 into the second orientation involves rotation of the clutch members 106. In some examples, the clutch members 106 rotate between the first and second orientations in unison. In other examples, the clutch members 106 rotate between the first and second orientations out of unison. This can be accomplished by design, or by inherent design intolerances in manufacturing the clutch assembly 100.

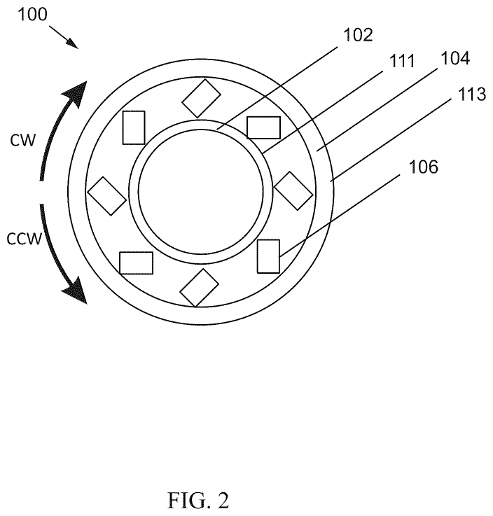

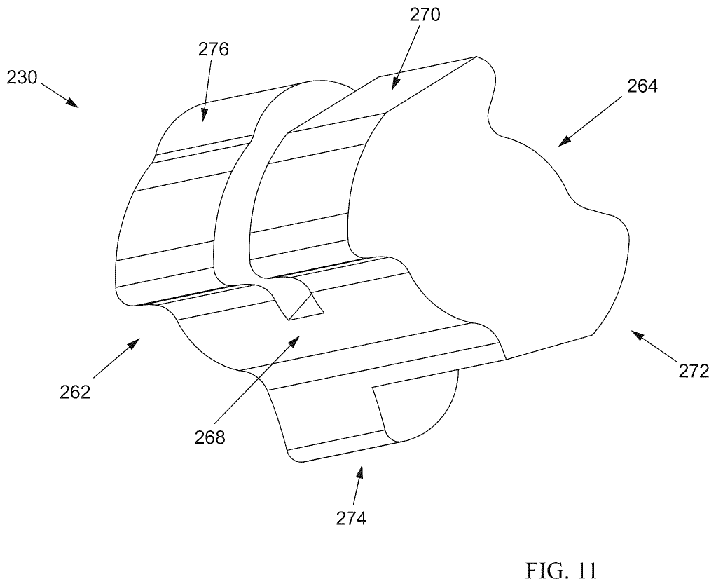

FIG. 2 illustrates the clutch members 106 in a second orientation. In the example of FIG. 2, the clutch members are oriented as to restrict the rotation between the inner rotatable member 102 and the outer rotatable member 104 in the second direction. In the example of FIG. 2, the clutch members are rotated by the relative movement between the inner rotatable member 102 and the outer rotatable member 104 so as to contact the outer surface of the inner rotatable member 102 and the outer rotatable member 104. When forced into the second orientation, the clutch members 106 are placed into an engaged state in which the clutch members contact both the inner rotatable member 102 and the outer rotatable member 104. In some examples, (as described with reference to the examples of FIGS. 11-12, 14-15, 18-19, and 22-23) the clutch members 106 include a wedge portion that contacts a smooth portion of the outer surface of the inner rotatable member 102 and a smooth portion of the inner surface of the outer rotatable member 104. In some examples, the wedge portion of the clutch members 106 jams between the outer wedge bearing surface 111 of the inner rotatable member 102 and the inner wedge bearing surface 113 of the outer rotatable member to restrict the relative movement of the inner rotatable member 102 and outer rotatable member 104 in the second direction.

In some examples, once the clutch members 106 are moved into the second orientation and the relative movement between the inner rotatable member 102 and the outer rotatable member 104 is restricted, the inner rotatable member and the outer rotatable member 104 rotate in unison. For example, if the inner rotatable member 102 was driven to rotate in the direction CW while the outer rotatable member 104 was undriven and remained stationary, the clutch members 106 would rotate to the second position to engage between the inner rotatable member 102 and the outer rotatable member 104, thereby causing both the inner rotatable member 102 and the outer rotatable member 104 rotate in unison in the direction CW.

In some examples, the engagement between the clutch members 106, inner rotatable member 102 and outer rotatable member 104 may be insufficient to withstand the torque that drives the relative rotation between the inner rotatable member 102 and the outer rotatable member 104 in the second direction. Such scenarios may occur, for example, if too few clutch members 106 are arranged between the inner rotatable member 102 and the outer rotatable member 104. In this scenario, slippage may occur between the clutch members 106 and the inner rotatable member 102 and the outer rotatable member 104. For example, contact between the wedge portion of the clutch members 106 and the smooth portion of the outer surface of the inner rotatable member 102 may slip, and/or the contact between the smooth portion of the inner surface of the outer rotatable member 104 may slip.

In some examples, when the torques applied to the clutch assembly 100 are sufficient to overcome the engagement between the clutch members 106 and the inner rotatable member 102 and the outer rotatable member 104 when the clutch members 106 are positioned in the second orientation, the clutch members 106 are rotated into the third orientation. In some examples, the movement of the clutch members 106 into the third orientation is driven by the contact between the clutch members 106 and the inner rotatable member 102 and/or the outer rotatable member 104. In some examples, movement of the clutch members 106 into the third orientation involves rotation of the clutch members 106. In some examples, the clutch members 106 rotate between the second and third orientations in unison. In other examples, the clutch members 106 rotate between the second and third orientations out of unison. This can be accomplished by design, or by inherent design intolerances in manufacturing the clutch assembly 100.

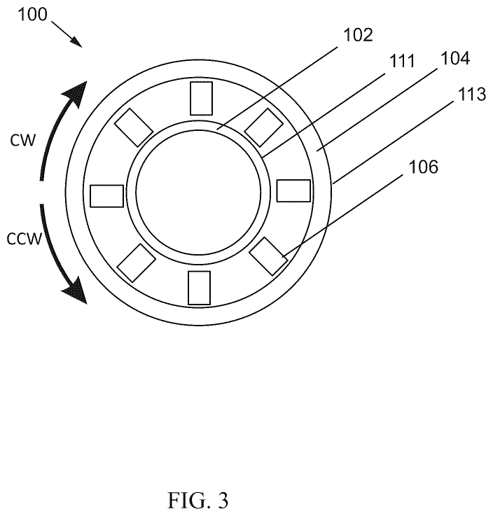

FIG. 3 illustrates the clutch members 106 in a third orientation. In the example of FIG. 3, the clutch members are oriented as to further restrict the rotation between the inner rotatable member 102 and the outer rotatable member 104 in the second direction. In the example of FIG. 3, the clutch members are rotated from the second orientation into the third orientation by slight relative movement of the inner rotatable member 102 and the outer rotatable member 104. In some examples, the slight relative movement of the inner rotatable member 102 and the outer rotatable member 104 is caused by slipping between the contact between the outer rotatable member 104 and the clutch members 106 or slipping between the contact between the inner rotatable member 102 and the clutch members 106. In some examples, the clutch members 106 include an interlock portion. In some examples, the interlock portion of the clutch members 106 is configured to engage with features arranged on one or both of the outer surface of the inner rotatable member 102 and the inner surface of the outer rotatable member 104. In some examples, the engagement between the interlock portion of the clutch members 106 and the features arranged on one or both of the outer surface of the inner rotatable member 102 and the inner surface of the outer rotatable member 104 further restricts the relative rotation between the inner rotatable member 102 and the outer rotatable member 104. In some examples, the engagement of the interlock portion of the clutch members 106 occurs after the engagement of the wedge portion of the clutch members 106.

The clutch assembly 100 may be adapted for use in various different applications, such as, for example, automotive applications, aviation applications, machine tool and hand tool applications, or bicycle applications.

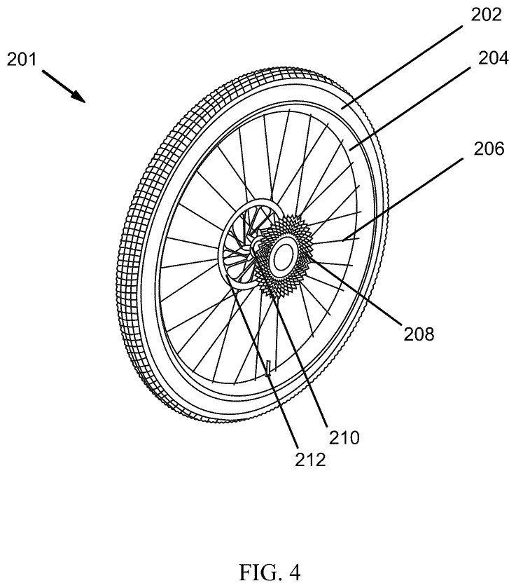

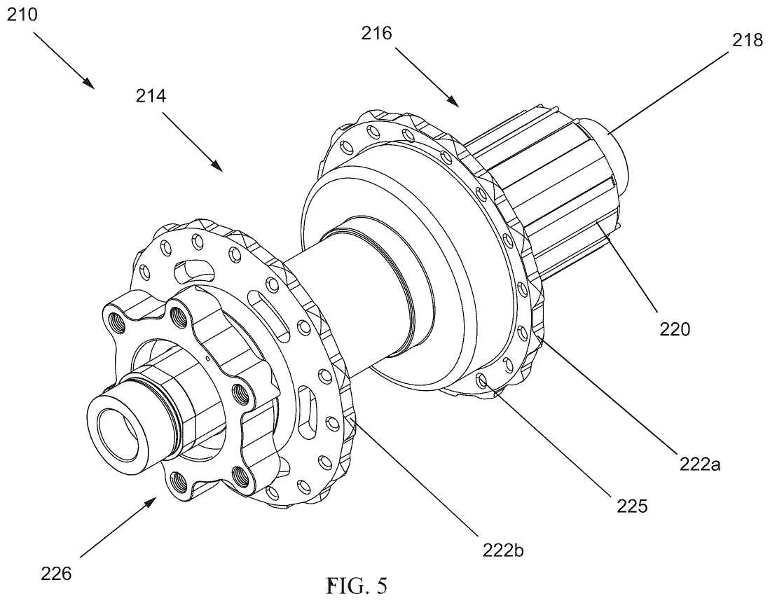

FIG. 4 depicts an example bicycle wheel 201 for a bicycle in which the example clutch assembly 100 is implemented. The example bicycle wheel 201 includes a tire 202, a rim 204, spokes 206, a cassette 208, a hub 210, and a disk brake 212. The hub 210 includes a hub shell 214 and a freehub 216 (shown in FIG. 5). The tire 202 is arranged around the rim 204 to provide a riding surface for the bicycle. The rim 204 is attached to the hub shell 214 by the spokes 206, which extend between the hub shell 214 and the rim 204 and are spaced circumferentially around the hub shell 214 about the axis of rotation relative to one another. The disk brake 212 is attached to the hub shell 214 at one end of the hub 210 and is able to engage with a brake on the bicycle to stop the rotation of the bicycle wheel 201. The cassette 208 is attached to the freehub 216 at a second end of the hub 210 and includes one or more gears. The cassette 208 is rotatably fixed to the freehub so that the cassette 208 and the freehub rotate in unison. The cassette 208 and the freehub 216 are permitted to rotate with respect to the hub shell 214 in a first direction, but are restricted from rotating with respect to the hub shell 214 in a second direction. When affixed to a bicycle, a chain (or belt) may be routed around the cassette 208 and connected to a chainring on a bicycle. When a user pedals the bicycle, the chainring rotates, and drives the movement of the chain. The movement of the chain causes the rotation of the cassette 208. When the wheel is stationary, the rotation of the cassette 208 initiates relative rotation between the cassette 208 and the hub shell 214 (along with the rim 204 and the tire 202) in the second direction. However, because the cassette 208 and the hub shell 214 are restricted from rotating relative to each other in the second direction, the movement of the cassette 208 in the second direction drives the movement of the hub shell 214 in the second direction, which causes the rim 204 and the tire 202 to rotate and propel the bicycle forward.

If a user stops pedaling while the bicycle is moving, the cassette 208 stops rotating, as it is no longer rotated by the movement of the chain. However, because the bicycle remains moving, the rim 204, tire 202, and hub shell 214 continue to rotate. The rotation of the hub shell 214 while the cassette 208 and freehub 216 remain stationary results in the respective rotation between the hub shell 214 and the freehub 216 in the first direction. Because the respective rotation between the hub shell 214 and the freehub 216 is permitted by the hub 210, the user is able to coast and ride the bicycle without pedaling.

FIG. 5 is a perspective view of the hub 210. As noted above, the hub includes a hub shell 214 and a freehub 216. In some examples, the hub 210 further includes an axel assembly 218 that extends through both the hub shell 214 and the freehub 216. The axel assembly 218 is independently rotatable with respect to the hub shell 214 and the freehub 216 in both the first and the second directions.

The freehub 216 includes a plurality of splines 220 arranged thereon. In some examples, the splines 220 are arranged in a particular pattern to match up with a plurality of recesses for receiving the splines 220 in the cassette 208. Examples of splines 220 are described in U.S. Pat. No. 10,113,597, the entirety of which is hereby incorporated by reference. As noted above, the freehub 216 is configured to be rotatable with respect to the hub shell 214 in a first direction and is restricted from rotating with respect to the hub shell 214 in a second direction.

The hub shell 214 includes a first and second flange 222a, 222b extending radially outward from the hub 210. In some examples, the first and second flange 222a, 222b are spaced apart from each other along the length of the hub shell 214. The first and second flange each include a plurality of spoke engagement members 225, which are formed as holes through each of the first and second flange 222a, 222b that are spaced circumferentially apart from one another. In some examples, the hub shell 214 also includes a disk brake attachment portion 226 on the end of the hub 210 opposite the freehub 216. The disk brake attachment portion 226 allows for a disk brake 212 to be mounted and attached to the hub shell 214.

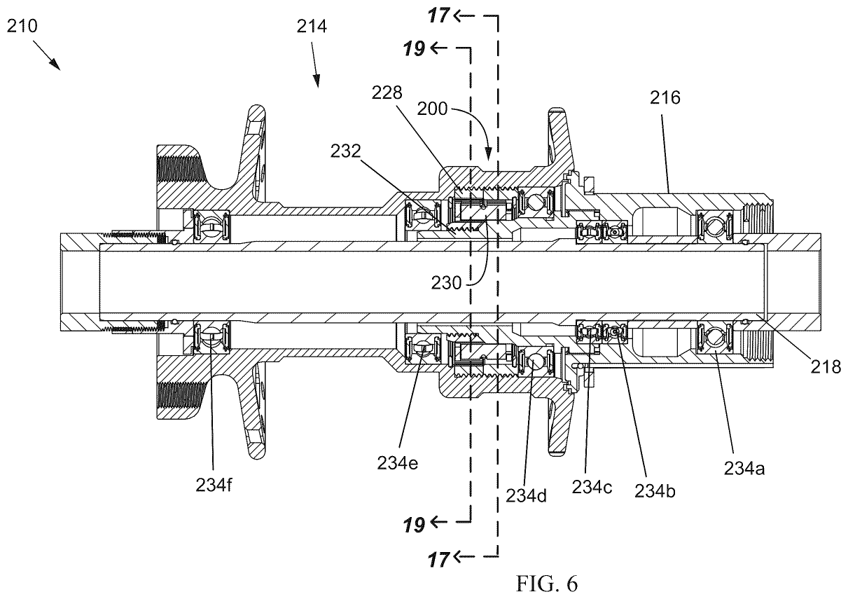

FIG. 6 is a cross sectional frontal view of the hub 210. As shown in FIG. 6, the hub 210 includes the hub shell 214, the freehub 216, and the axel assembly 218. The hub 210 further includes a clutch assembly 200 and bearings 234a-f. The clutch assembly 200 includes an outer sleeve assembly 228, clutch members 230, and an inner sleeve assembly 232.

The bearings 234a-f directly or indirectly facilitate rotation between the axel assembly 218, hub shell 214, and the freehub 216. As shown in FIG. 6, bearing 234a facilitates rotation between the freehub and the axel assembly 218. Bearing 234b facilitates rotation between the freehub 216 and the axel assembly. Bearing 234c facilitates rotation between the inner sleeve assembly 232 and the axel assembly 218. Bearings 234d-e facilitate rotation between the inner sleeve assembly 232 and the hub shell 214. Bearing 234f facilitates rotation between the hub shell 214 and the axel assembly 218.

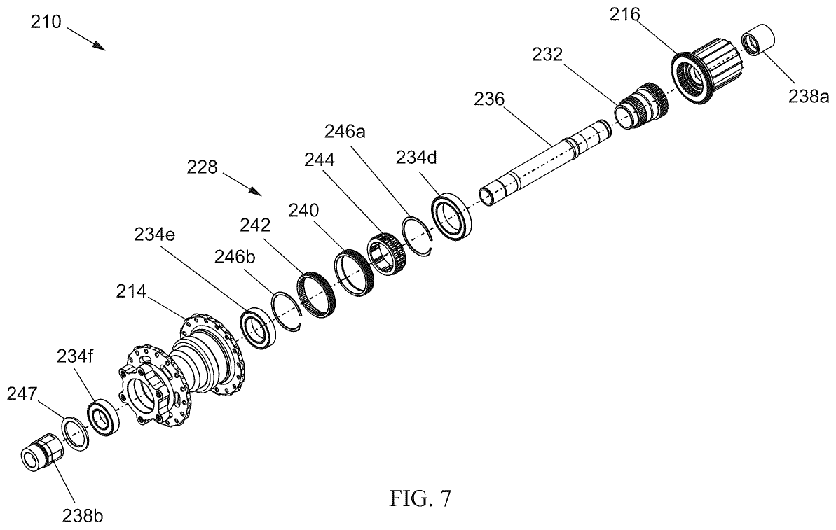

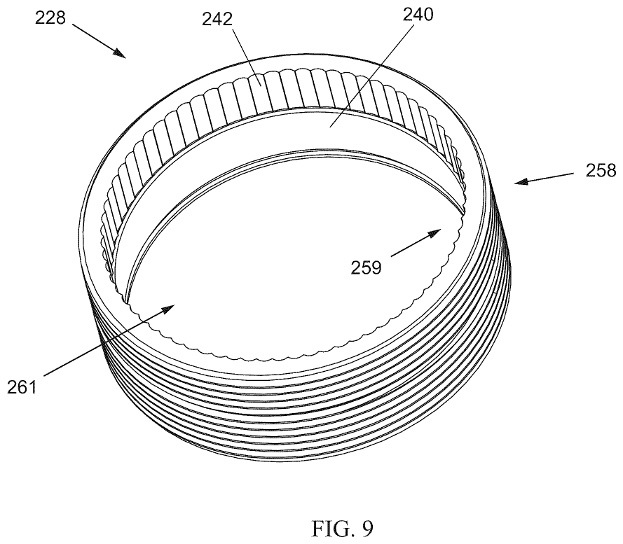

FIG. 7 is an exploded perspective view of the hub 210 of FIG. 6. In the example of FIG. 7, the axel assembly 218 includes an axel 236 and endcaps 238a, 238b. The outer sleeve assembly 228 (shown in FIG. 9) includes a smooth clutch contacting portion 240 and a featured clutch contacting portion 242. In the example of FIG. 7, the clutch members 230 are also included and are held in place within a clutch frame assembly 244.

Bearings 234 a-c are arranged within the freehub 216 and are not shown in FIG. 7.

The hub 210 further includes retaining rings 246a, 246b, and dust cover 247.

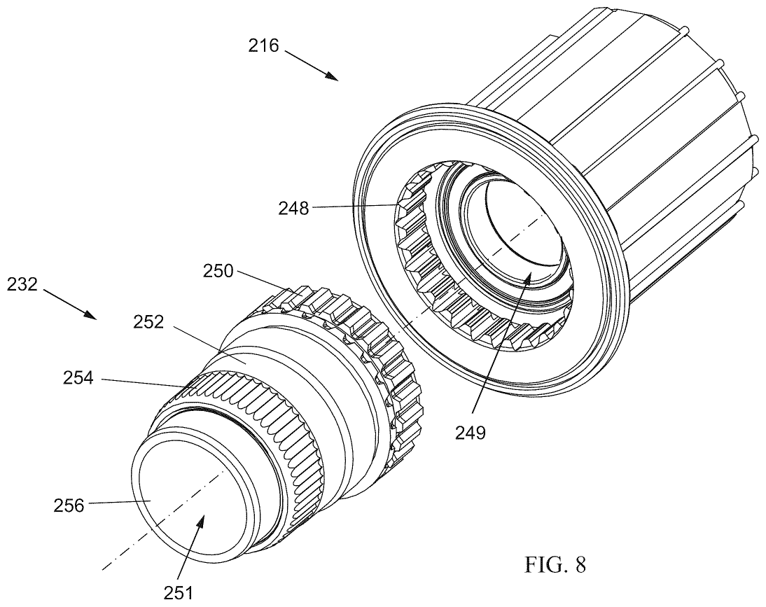

FIG. 8 is an exploded perspective view of the freehub 216 and the inner sleeve assembly 232 of the hub 210. Although the example of FIG. 8 and the description below describes the freehub 216 and inner sleeve assembly 232 as two separate pieces, it should be recognized that the inner sleeve assembly 232 and the freehub 216 may also be made from a single, unitary piece.

As shown in FIG. 8, the freehub 216 includes an inner space 249 that extends through the freehub 216 for receiving the axel assembly 218 and the inner sleeve assembly 232. The inner space 249 includes a plurality of inner sleeve engagement features 248 circumferentially arranged on an inner surface of the freehub 216. As seen in FIG. 8, the inner sleeve engagement features 248 are teeth.

The inner sleeve assembly 232 also includes an inner space 251 that extends through the inner sleeve assembly 232, through which the axel assembly 218 extends. In some examples, the inner sleeve assembly 232 also includes a body 256, a smooth clutch contacting portion 252, a featured clutch contacting portion 254, and freehub engagement features 250. In some examples, the freehub engagement features 250 are circumferentially arranged on an outer surface of the inner sleeve assembly 232. In some examples, the freehub engagement features 250 are teeth. In some examples, a portion of the inner sleeve assembly 232 is configured to be received within the end of the freehub 216 so that the freehub engagement features 250 of the inner sleeve assembly 232 are received within the freehub 216 and contact the inner sleeve engagement features 248 of the freehub 216. In some examples, the teeth of the freehub engagement features 250 mate with the teeth of the inner sleeve engagement features 248. In this way, the freehub 216 and the inner sleeve assembly 232 are rotatably fixed together so that the inner sleeve assembly 232 and the freehub 216 rotate in unison with each other.

In some examples, the smooth clutch contacting portion 252 and the featured clutch contacting portion 254 are configured to extend outwardly and are not received within the freehub 216.

The outer surface of the smooth clutch contacting portion 252 is smooth relative to the featured clutch contacting portion 254. In some examples, the smooth clutch contacting portion 252 is a smooth metal cylindrical surface, while in other examples, the smooth clutch contacting portion 252 is textured and may include ridges or knurling.

In some examples, the outer surface of the featured clutch contacting portion 254 includes a plurality of teeth or ridges. In other examples, the featured clutch contacting portion 254 includes knurling. In some examples, the featured clutch contacting portion includes a set of gear teeth.

In some examples, the featured clutch contacting portion 254, the freehub engagement features 250, and/or the smooth clutch contacting portion 252 are formed separately from the body 256 of the inner sleeve assembly 232. In some examples, the freehub engagement features 250, the smooth clutch contacting portion 252, and/or the featured clutch contacting portion 254 are secured to the body 256 by threads or a press-fit style connection.

FIG. 9 is a perspective view of the outer sleeve assembly 228. In some examples, the outer sleeve assembly 228 is formed as a ring with an outer surface 258 and an inner surface 259. In some examples, the outer sleeve assembly 228 includes an opening 261 that extends through the outer sleeve assembly 228. In some examples, the opening 261 includes an inner diameter that is defined by the inner surface 259 of the outer sleeve assembly 228. The diameter of the opening 261 is larger than the diameter of the outer surface of the smooth clutch contacting portion 252 or the featured clutch contacting portion 254 of the inner sleeve assembly 232. As described above with reference to FIG. 7, the outer sleeve assembly 228 includes a smooth clutch contacting portion 240 and a featured clutch contacting portion 242. In some examples, the smooth clutch contacting portion 240 is smooth relative to the featured clutch contacting portion 242. In some examples, the smooth clutch contacting portion 240 is a smooth metal cylindrical surface, while in other examples, the smooth clutch contacting portion 240 is lightly textured and includes small ridges or knurling. In some examples, the featured clutch contacting portion 242 includes a plurality of teeth or ridges. In other examples, the featured clutch contacting portion 242 includes knurling.

In some examples, as depicted in FIG. 7, the smooth clutch contacting portion 240 and the featured clutch contacting portion 242 are formed as separate pieces. In other examples, the smooth clutch contacting portion 240 and the featured clutch contacting portion 242 are formed as a single unitary piece.

In some examples, the outer sleeve assembly 228 is formed integrally with the hub shell 214. In other examples, such as the example of FIG. 9, the outer sleeve assembly 228 is insertable within the hub shell 214. In some examples, such as in the example of FIG. 9 the outer sleeve assembly 228 includes threads on the outer surface 258. In some examples, the threads engage with corresponding threads on the inner surface of the hub shell 214, which secure the outer sleeve assembly 228 in place within the hub shell. 214. In other examples, the outer sleeve assembly 228 is press fit into the hub shell 214 or inserted into the hub shell 214 in a lock and key style configuration. In some examples, the outer sleeve assembly 228 is rotatably fixed in relation to the hub shell 214. In other examples, such as when the outer sleeve assembly 228 is secured to the hub shell 214 with threads, the outer sleeve assembly 228 is rotatably fixed in relation to the hub shell 214 in a first direction, but is permitted to rotate in relation to the hub shell 214 in a second direction. In some examples, while in use on the hub 210, the outer sleeve assembly 228 is only subject to significant torque in a single direction, which only serves to tighten the threads onto the hub shell 214 and fix the rotation of the outer sleeve assembly 228 in relation to the hub shell 214.

As described above with reference to FIGS. 8 and 9, in some examples, each of the inner sleeve assembly 232 and the outer sleeve assembly 228 include a smooth clutch contacting portion 252, 240 and a featured clutch contacting portion 254, 242. In some examples, the inner sleeve assembly 232 and/or the outer sleeve assembly 228 are constructed to only include one of the smooth clutch contacting portion 252, 240 or the featured clutch contacting portion 254, 242. For example, the outer sleeve assembly 228 could be constructed with both of the smooth clutch contacting portion 240 and the featured clutch contacting portion 242 while the inner sleeve assembly includes only a smooth clutch contacting portion 252 that extends along the region of the inner sleeve assembly 232 where both the smooth clutch contacting portion 252 and the featured clutch contacting portion 254 extend in the embodiment shown in FIG. 8. Thus, when the inner sleeve assembly 232 and the outer sleeve assembly 228 are assembled into the hub 210 and arranged in the manner shown in FIG. 6, the smooth clutch contacting portion 240 and the featured clutch contacting portion 242 of the outer sleeve assembly 228 are both laterally aligned with the smooth clutch contacting portion 252 of the inner sleeve assembly 232.

Alternatively, for example, the inner sleeve assembly 232 could be constructed with both of the smooth clutch contacting portion 252 and the featured clutch contacting portion 254 while the outer sleeve assembly 228 includes only a smooth clutch contacting portion 240 that extends along the region of the outer sleeve assembly 228 where both the smooth clutch contacting portion 240 and the featured clutch contacting portion 242 extend in the embodiment shown in FIG. 9. Thus, when the inner sleeve assembly 232 and the outer sleeve assembly 228 are assembled into the hub 210 and arranged in the manner shown in FIG. 6, the smooth clutch contacting portion 252 and the featured clutch contacting portion 254 of the inner sleeve assembly 232 are both laterally aligned with the smooth clutch contacting portion 240 of the outer sleeve assembly 228.

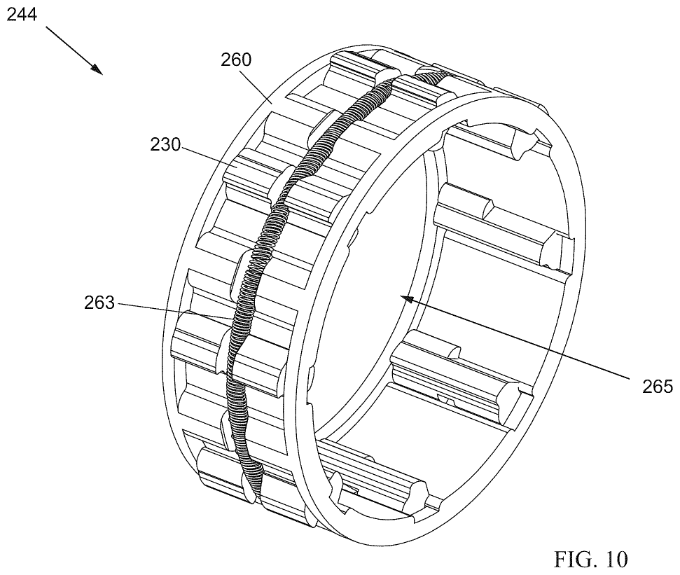

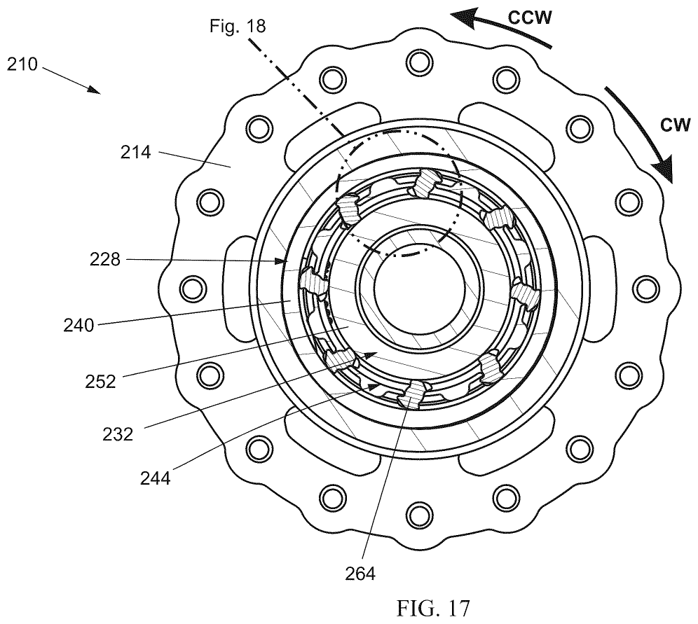

FIG. 10 is a perspective view of an example clutch frame assembly 244. In some examples, the clutch frame assembly 244 includes a frame 260 and one or more clutch members 230. In some examples, the clutch frame assembly 244 further includes a retaining spring 263 that wraps around the circumference of the frame 260 to help retain the clutch members 230 in place on the frame 260. In the example of FIG. 10, the clutch members 230 are permitted to rotate in place on the frame. In some examples, as described with reference to FIGS. 17-28, the clutch members are permitted to rotate between a first, second, and third orientation. In some examples, the frame 260 includes an opening 265. The opening 265 has an inner diameter that is larger than the diameter of the smooth clutch contacting portion 252 and the featured clutch contacting portion 254 of the inner sleeve assembly 232. In some examples, the opening 265 of the frame 260 has an outer diameter that is smaller than the diameter of the opening 261 of the outer sleeve assembly 228. In some examples, the clutch frame assembly 244 is arranged within the hub 210 so that the inner sleeve assembly 232 extends within the opening 265 of the clutch frame assembly 244 and the clutch frame assembly 244 is within the opening 261 of the outer sleeve assembly 228. In this example, the clutch frame assembly 244 is arranged radially between the inner sleeve assembly 232 and the outer sleeve assembly 228. In some examples, when arranged in this configuration, the smooth clutch contacting portion 252 of the inner sleeve assembly 232 is configured to be arranged at the same lateral position relative to the smooth clutch contacting portion 240 of the outer sleeve assembly 228 and the featured clutch contacting portion 254 of the inner sleeve assembly 232 is arranged at the same lateral position relative to the featured clutch contacting portion 242 of the outer sleeve assembly 228.

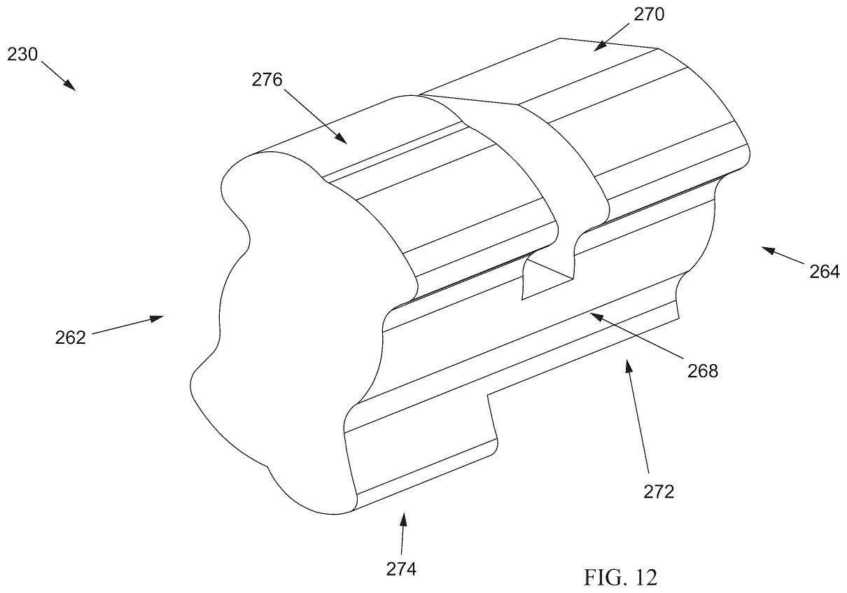

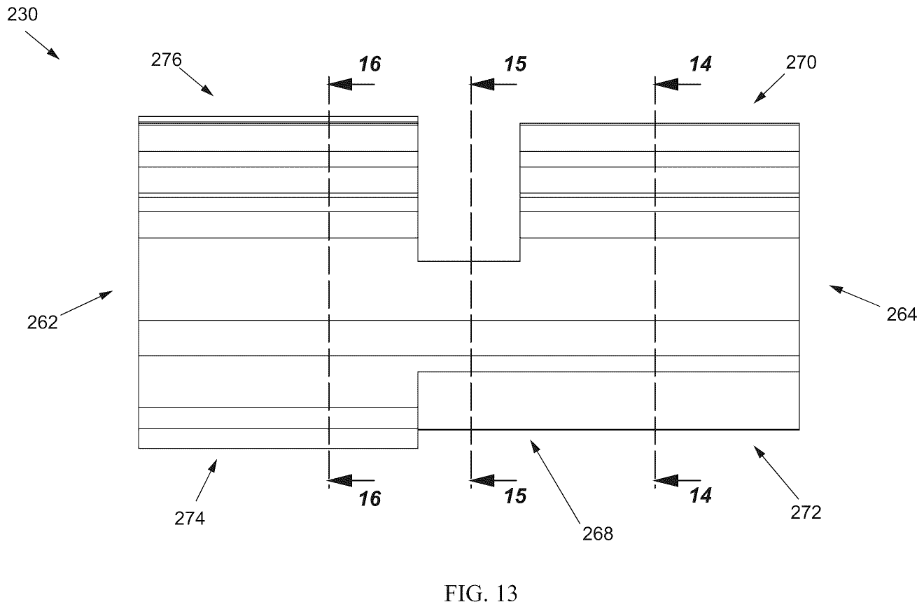

FIGS. 11-12 are perspective views of an example clutch member 230, and FIG. 13 is a front view of the example clutch member 230. The example clutch member 230 includes a wedge portion 264 and an interlocking portion 262. In some examples, the clutch member 230 further includes a transition portion 268. In some examples, the wedge portion 264 is arranged on a first side of the clutch member 230, the interlocking portion 262 is arranged on a second side of the clutch member 230, and the transition portion 268 is arranged between the wedge portion 264 and the interlocking portion 262. In some examples, the retaining spring is arranged to contact the transition portion 268 and is held in place by the wedge portion 264 and the interlocking portion 262. In some examples, when the clutch frame assembly 244 is arranged between the inner sleeve assembly 232 and the outer sleeve assembly 228, as described with reference to FIG. 10, the clutch members 230 are arranged so that the wedge portion 264 is laterally aligned with the smooth clutch contacting portion 240 of the outer sleeve assembly 228 and the smooth clutch contacting portion 252 of the inner sleeve assembly 232. Likewise, the interlocking portion 262 is laterally aligned with the featured clutch contacting portion 242 of the outer sleeve assembly 228 and the featured clutch contacting portion 254 of the inner sleeve assembly 232.

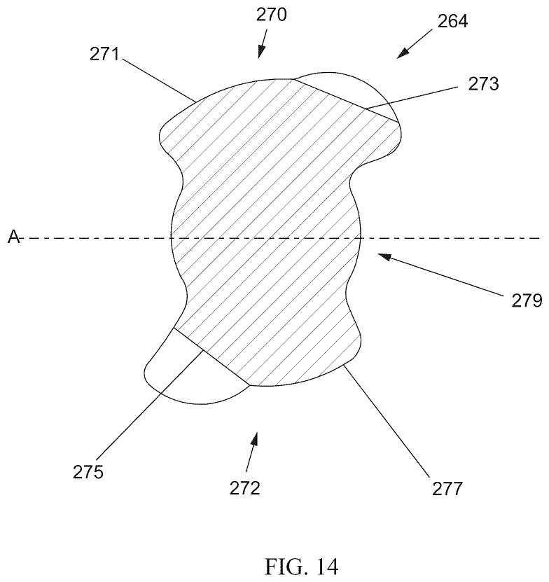

FIG. 14 is a cross sectional view of the wedge portion 264 of the example clutch member 230, taken along line 14 in FIG. 14. The wedge portion 264 includes an outer sleeve wedge portion 270 and an inner sleeve wedge portion 272. In some examples, when placed into the clutch frame assembly 244, the outer sleeve wedge portion 270 is configured to engage with the smooth clutch contacting portion 240 of the outer sleeve assembly 228 and the inner sleeve wedge portion 272 is configured to engage with the smooth clutch contacting portion 252 of the inner sleeve assembly 232. In some examples, as depicted in FIG. 14, each of the outer sleeve wedge portion 270 and the inner sleeve wedge portion 272 includes a rounded portion 271, 277 and a slanted portion 273, 275. In some examples, the slanted portion 275 on the inner sleeve wedge portion 272 is oriented at a greater angle with respect to horizontal reference line A than the slanted portion 273 on the outer sleeve wedge portion 270. In some examples, the wedge portion also includes an intermediate portion 279 that extends between the outer sleeve wedge portion 270 and the inner sleeve wedge portion 272 with curved convex sides. In some examples, the wedge portion 264 is shaped as an asymmetric figure-eight shaped sprag.

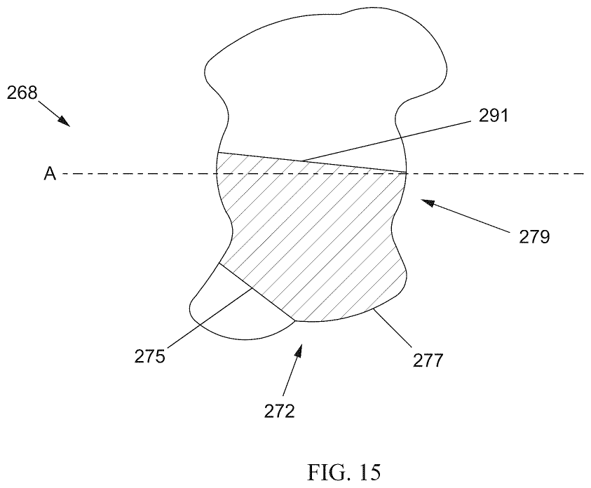

FIG. 15 is a cross sectional view of the transition portion 268 of the example clutch member 230, taken along line 15 in FIG. 13. As seen in FIG. 15, the transition portion 268 includes the slanted portion 275 and the round portion 277 of the wedge portion 272. In some examples, the transition portion 268 also includes a portion of the intermediate portion 279. In some examples, the transition portion 268 also includes a top slanted portion 291. In some examples, the retaining spring 263 contacts the top slanted portion 291 when the clutch member is placed into the clutch frame assembly 244.

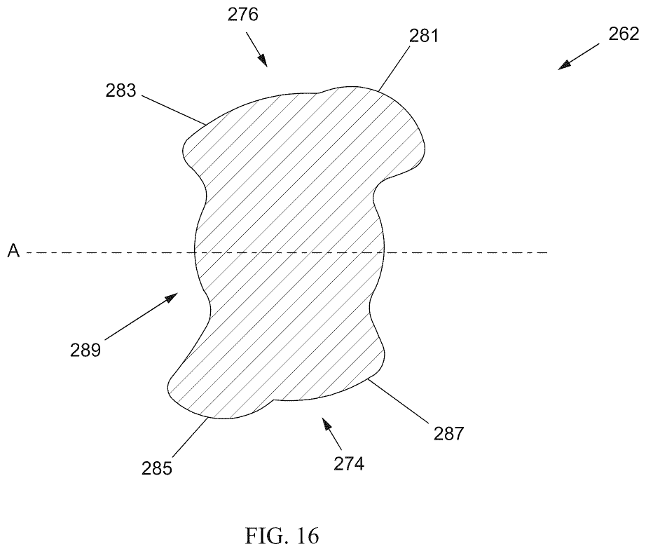

FIG. 16 is a cross sectional view of the interlocking portion 262 of the example clutch member 230, taken along line 16 in FIG. 13. The interlocking portion 262 includes an outer sleeve interlocking portion 276 and an inner sleeve interlocking portion 274. In some examples, when placed into the clutch frame assembly 244, the outer sleeve interlocking portion 276 is configured to engage with the featured clutch contacting portion 242 of the outer sleeve assembly 228 and the inner sleeve interlocking portion 274 is configured to engage with the featured clutch contacting portion 254 of the inner sleeve assembly 232. In some examples, as depicted in FIG. 16, each of the outer sleeve interlocking portion 276 and the inner sleeve interlocking portion 274 include a first lobe 281, 285 and a second lobe 283, 287. In the example of FIG. 16, the first lobes 281, 285 are larger and more pronounced than the second lobes 283, 287. In some examples, the interlocking portion 262 includes an intermediate portion 279 that extends between the outer sleeve interlocking portion 276 and the inner sleeve interlocking portion 274 with curved convex sides. In some examples, each of the lobes 281, 283, 285, 287 include a curved transition between the lobes 281, 283, 285, 287 and the transition portion. In some examples, as illustrated in FIG. 16, the radius of curvature of the curved transition between the first lobe 281 of the outer sleeve interlocking portion 276 and the transition portion 289 is larger than the radius of curvature of the curved transition between the first lobe 285 of the inner sleeve interlocking portion 274 and the transition portion 289.

As noted above with respect to FIGS. 8 and 9, in some embodiments, the inner sleeve assembly 232 and the outer sleeve assembly 228 may be constructed such that the inner sleeve assembly 232 and/or the outer sleeve assembly 228 includes only one of the smooth clutch contacting portion 252, 240 or the featured clutch contacting portion 254, 242. In these embodiments, the clutch members 230 may be constructed in an analogous manner. For example, in an alternative embodiment, if the outer sleeve assembly 228 were constructed with both of the smooth clutch contacting portion 240 and the featured clutch contacting portion 242 while the inner sleeve assembly 232 included only a smooth clutch contacting portion 252, the clutch members 230 could be constructed such that each clutch member 230 includes an outer sleeve interlocking portion 276 and an outer sleeve wedge portion 270. However, rather than including both the inner sleeve interlocking portion 274 and the inner sleeve wedge portion 272, each element would only include an inner sleeve wedge portion 272 that extends across where both the inner sleeve wedge portion 272 and the inner sleeve interlocking portion 274 are arranged in FIG. 11.

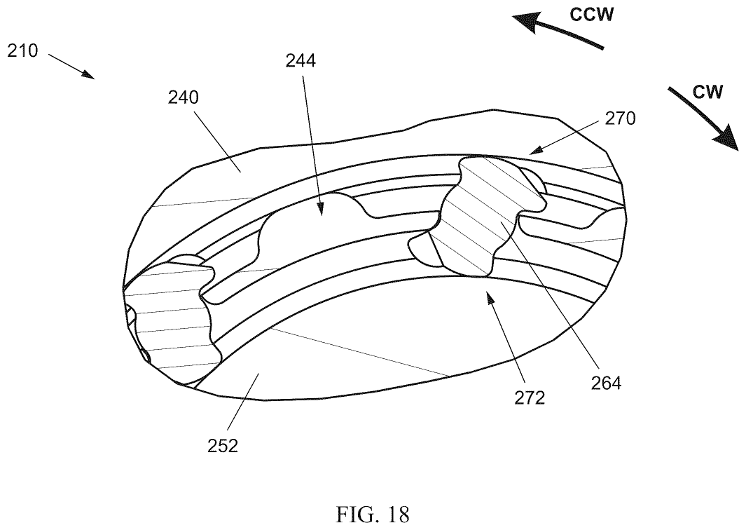

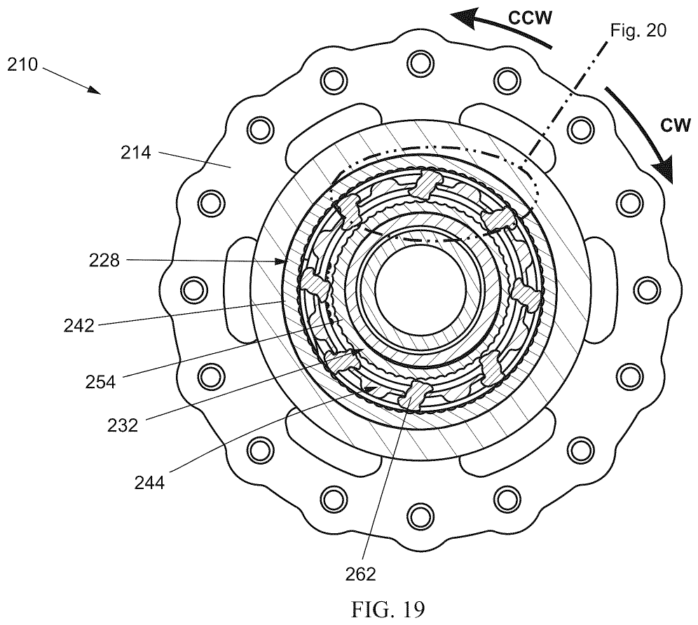

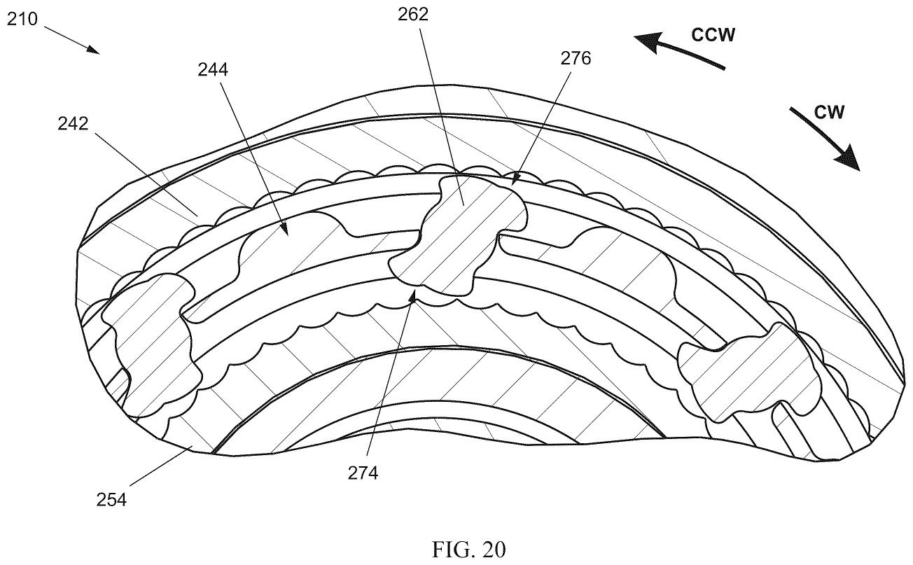

FIGS. 17-20 are cross sectional side views of an example hub 210 with the clutch members 230 arranged in a first orientation. FIGS. 17 and 19 are cross sectional side views of the entire hub 210. FIG. 18 is a zoomed in cross sectional side view of FIG. 17, and FIG. 20 is a zoomed in cross sectional side view of FIG. 19. As seen in FIGS. 17 and 19, the hub 210 includes the clutch frame assembly 244 radially disposed in between the inner sleeve assembly 232 and the outer sleeve assembly 228. The clutch members 230, outer sleeve assembly 228, and inner sleeve assembly 232 are all aligned so that the wedge portion 264 is laterally aligned with the smooth clutch contacting portion 240 of the outer sleeve assembly 228 and the smooth clutch contacting portion 252 of the inner sleeve assembly 232. Likewise, the interlocking portion 262 is laterally aligned with the featured clutch contacting portion 242 of the outer sleeve assembly 228 and the featured clutch contacting portion 254 of the inner sleeve assembly 232.

The FIGS. 17 and 18 depict the wedge portion 264 of the clutch members 230 (along line 17 in FIG. 6), while FIGS. 19 and 20 depict the interlocking portion 262 of the clutch members 230 (along line 19 in FIG. 6).

As seen in FIGS. 17 and 18, when placed in the first orientation, the outer sleeve wedge portion 270 of the wedge portion 264 of the clutch members 230 lightly contacts the smooth clutch contacting portion 240 of the outer sleeve assembly 228 and the inner sleeve wedge portion 272 of the wedge portion 264 of the clutch members 230 lightly contacts the smooth clutch contacting portion 252 of the inner sleeve assembly 232. Specifically, the rounded portion 271 of the outer sleeve wedge portion 270 lightly contacts the smooth clutch contacting portion 240 of the outer sleeve assembly 228 and the rounded portion 277 of the inner sleeve wedge portion 272 lightly contacts the smooth clutch contacting portion 252 of the inner sleeve assembly 232. In some embodiments, when placed in the first orientation, the clutch members 230 do not contact the smooth clutch contacting portion 240 of the outer sleeve assembly 228. In some embodiments, when placed in the first orientation, the clutch members 230 do not contact the smooth clutch contacting portion 252 of the inner sleeve assembly 232.

As seen in FIGS. 19 and 20, when placed in the first orientation, the outer sleeve interlocking portion 276 of the clutch members 230 does not contact the featured clutch contacting portion 242 of the outer sleeve assembly 228. Likewise, the inner sleeve interlocking portion 274 of the clutch members 230 does not contact the featured clutch contacting portion 254 of the inner sleeve assembly 232. In other embodiments, the outer sleeve interlocking portion 276 of the clutch members 230 lightly contacts the featured clutch contacting portion 242 of the outer sleeve assembly 228. In other embodiments, the inner sleeve interlocking portion 274 of the clutch members 230 lightly contacts the featured clutch contacting portion 254 of the inner sleeve assembly 232. Specifically, in some examples, the second lobe 283 of the outer sleeve interlocking portion 276 lightly contacts the featured clutch contacting portion 242 of the outer sleeve assembly 228 while the second lobe 287 of the inner sleeve interlocking portion 274 lightly contacts the featured clutch contacting portion 254 of the inner sleeve assembly 232.

The terms “first and second directions of relative rotation” are used in the description of FIGS. 17-28 below. Description of the terms “first and second relative directions of rotation” is provided with reference to FIG. 1 above. Arrows CW and CCW provided in FIGS. 17-28 are analogous to arrows CW and CCW provided in FIGS. 1-3. Likewise, for the purposes of describing the first and second relative directions of rotation, inner sleeve assembly 232 is analogous to the inner rotatable member 102, and the outer sleeve assembly 228 is analogous to the outer rotatable member 104.

When in the first orientation, the clutch members 230 permit the relative rotation of the hub shell 214 and the outer sleeve assembly 228 in the first direction with respect to the inner sleeve assembly 232. For example, as shown in FIGS. 17-20, when in the first orientation, the clutch members 230 permits the relative rotation of the hub shell 214 and the outer sleeve assembly 228 the direction CW with respect to the inner sleeve assembly 232. In some embodiments, the clutch frame assembly 244 remains in substantially the same position with respect to the inner sleeve assembly 232. In other embodiments, the clutch frame assembly 244 remains in substantially the same position with respect to the outer sleeve assembly 228, in which case, the clutch frame assembly 244 rotates with respect to the inner sleeve assembly 232 along with the outer sleeve assembly 228.

In some embodiments, when the hub shell 214 and the outer sleeve assembly 228 are rotated in the second direction with respect to the inner sleeve assembly 232, such as, for example, in the direction opposite of the arrow CW, the clutch members 230 are moved into a second orientation. In some examples, such as in the example of FIGS. 17-20, the movement of the clutch members 230 is caused by the contact between the outer sleeve wedge portion 270 of the wedge portion 264 of the clutch members 230 and the smooth clutch contacting portion 240 of the outer sleeve assembly 228, along with the contact between the inner sleeve wedge portion 272 of the wedge portion 264 of the clutch members 230 and the smooth clutch contacting portion 252 of the inner sleeve assembly 232. Thus the frictional force from the contact between the clutch members 230 and the smooth clutch contacting portion 240 of the outer sleeve assembly 228 and the smooth clutch contacting portion 252 of the inner sleeve assembly 232 causes the rotation of the clutch members 230 into the second orientation as the outer sleeve assembly 228 is rotated in the second direction with respect to the inner sleeve assembly 232.

In some examples, the clutch members 230 rotate from the first orientation to the second orientation in unison. In other examples, the clutch members 230 rotate between the first and second orientations out of unison. This can be accomplished by design, or by inherent design intolerances in manufacturing the hub 210.

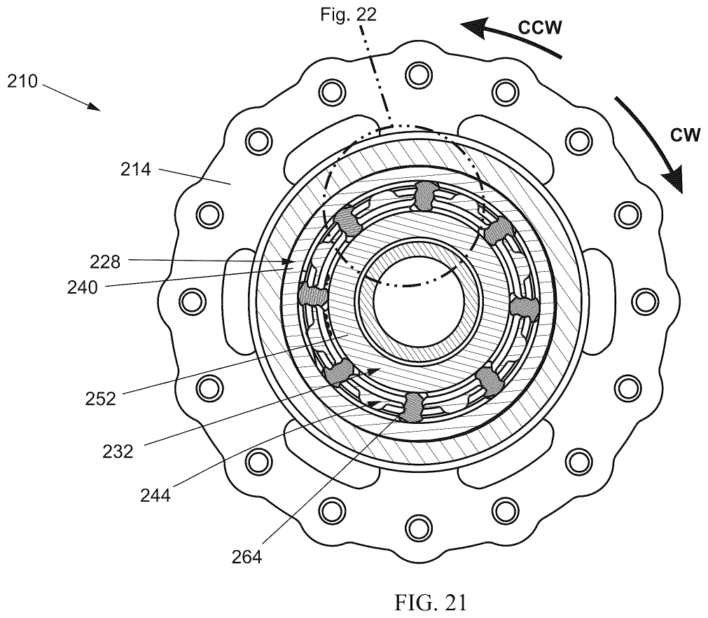

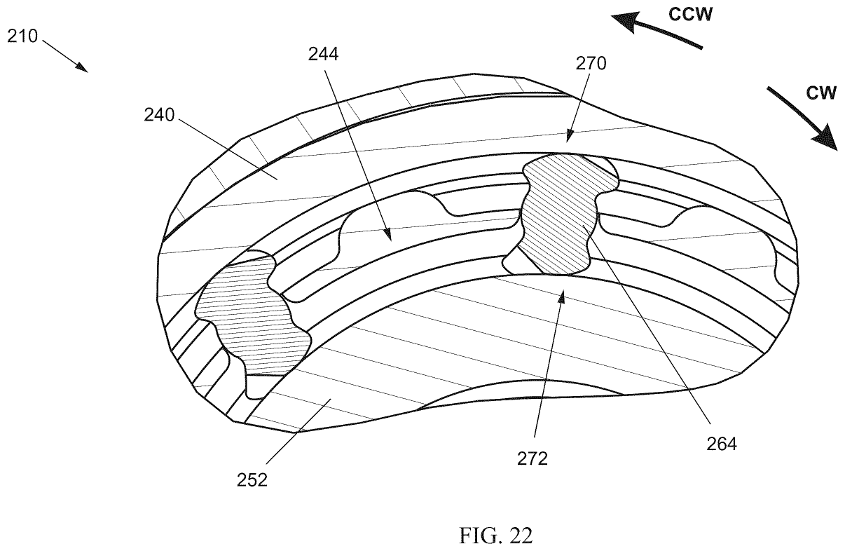

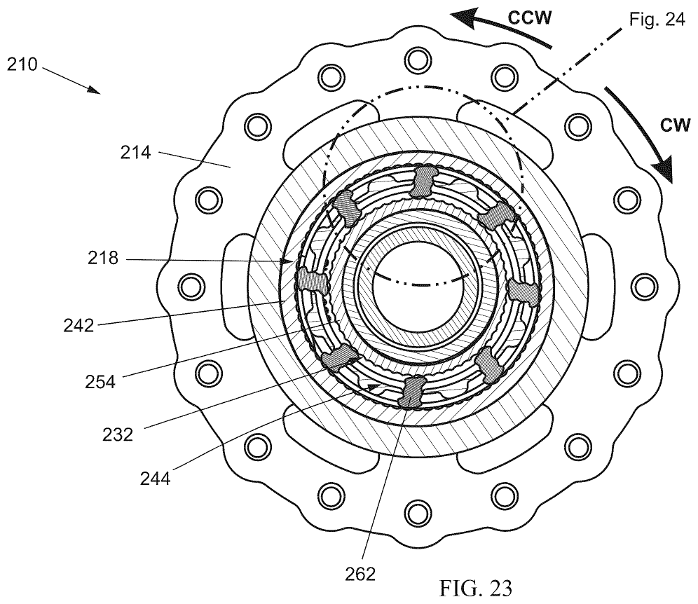

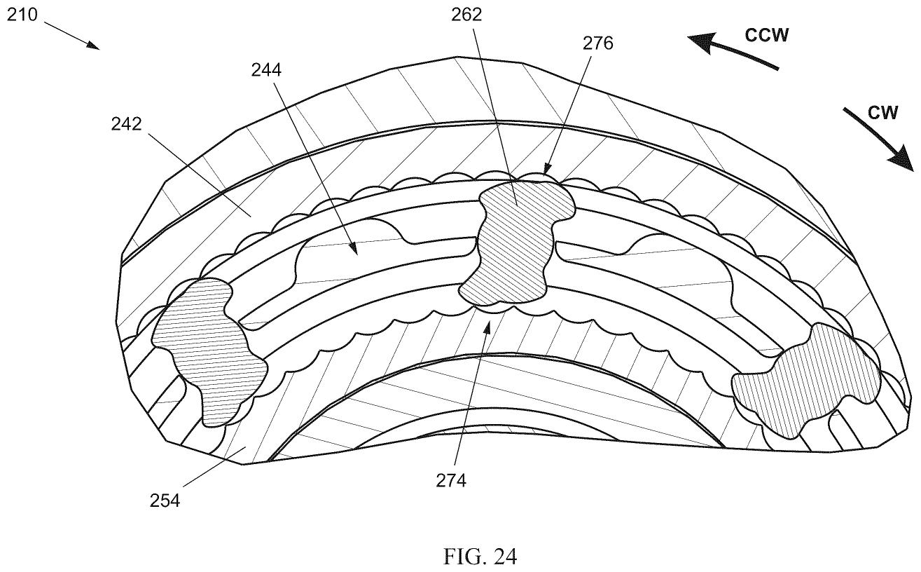

FIGS. 21-24 are cross sectional side views of an example hub 210 with the clutch members 230 arranged in the second orientation. FIGS. 21 and 23 are cross sectional side views of the entire hub 210. FIG. 22 is a zoomed in cross sectional side view of FIG. 21, and FIG. 24 is a zoomed in cross sectional side view of FIG. 23. FIGS. 21 and 22 depict the wedge portion 264 of the clutch members 230 (along cross section 17 in FIG. 6), while FIGS. 23 and 24 depict the interlocking portion 262 of the clutch members 230 (along line 19 in FIG. 6).

As seen in FIGS. 21 and 22, when placed in the second orientation, the clutch members 230 are rotated so that the outer sleeve wedge portion 270 of the wedge portion 264 of the clutch members 230 engages with the smooth clutch contacting portion 240 of the outer sleeve assembly 228 and the inner sleeve wedge portion 272 of the wedge portion 264 of the clutch members 230 engages the smooth clutch contacting portion 252 of the inner sleeve assembly 232. Specifically, the rounded portion 271 of the outer sleeve wedge portion 270 engages with the smooth clutch contacting portion 240 of the outer sleeve assembly 228 and the rounded portion 277 of the inner sleeve wedge portion 272 engages with the smooth clutch contacting portion 252 of the inner sleeve assembly 232. In some embodiments, the engagement of the wedge portions 264 of the clutch members 230 functions as a wedge between the inner sleeve assembly 232 and the outer sleeve assembly 228. This wedge operates to restrict the relative rotation of the hub shell 214 and the outer sleeve assembly 228 in the second direction with respect to the inner sleeve assembly 232. In some embodiments, if the hub shell 214 and the outer sleeve assembly 228 are rotated back in a first direction with respect to the inner sleeve assembly 232, the clutch members 230 are rotated back into the first orientation to permit the rotation in the first direction.

As seen in FIGS. 23 and 24, when placed in the second orientation, the clutch members 230 are rotated so that the outer sleeve interlocking portion 276 of the clutch members 230 lightly contacts the featured clutch contacting portion 242 of the outer sleeve assembly 228 and the inner sleeve interlocking portion 274 of the clutch members 230 lightly contacts the featured clutch contacting portion 254 of the inner sleeve assembly 232. Specifically, in some examples, the first lobe 281 of the outer sleeve interlocking portion 276 lightly contacts the featured clutch contacting portion 242 of the outer sleeve assembly 228 while the first lobe 285 of the inner sleeve interlocking portion 274 lightly contacts the featured clutch contacting portion 254 of the inner sleeve assembly 232. In other examples, the interlocking portion 262 of the clutch members 230 does not contact either of the featured clutch contacting portion 242 of the outer sleeve assembly 228 and/or the featured clutch contacting portion 254 of the inner sleeve assembly 232. In other examples, when placed in the second orientation, the interlocking portion 262 of the clutch members 230 contacts, but does not engage with the featured clutch contacting portion 242 of the outer sleeve assembly 228 or the featured clutch contacting portion 254 of the inner sleeve assembly 232 to restrict the rotation of the relative rotation of the hub shell 214 and the outer sleeve assembly 228 in the second direction with respect to the inner sleeve assembly 232. Rather, all engagement and restriction is performed by the wedge portion 264 when the clutch members 230 are positioned in the second orientation.

In some examples, a user of the hub 210 may apply significant amounts of torque to the hub when riding a bicycle. For example, if the user is pedaling hard uphill, the user will likely generate greater torque than if the user were pedaling lightly downhill. In some embodiments, if sufficient torque is applied to the hub 210 in a manner that operates to further rotate the hub shell 214 and the outer sleeve assembly 228 in the second direction with respect to the inner sleeve assembly 232, the engagement between the clutch members 230 and the smooth clutch contacting portion 240 of the outer sleeve assembly 228 and the smooth clutch contacting portion 252 of the inner sleeve assembly 232 may be insufficient to restrict the movement of the hub shell 214 and the outer sleeve assembly 228 in the second direction with respect to the inner sleeve assembly 232. In some examples, this is due to slippage between the clutch members 230 and the smooth clutch contacting portion 240 of the outer sleeve assembly 228 and the smooth clutch contacting portion 252 of the inner sleeve assembly 232. In some examples, adding additional clutch members 230 to the hub 210 will allow for the hub 210 to withstand greater torques in the second direction and minimize slippage between the clutch members 230 and the smooth clutch contacting portion 240 of the outer sleeve assembly 228 and the smooth clutch contacting portion 252 of the inner sleeve assembly 232. In some examples, however, adding additional clutch members 230 adds additional weight to the hub 210. In some applications, this additional weight may be undesirable.

In some examples, the clutch members 230 are rotated into a third orientation when sufficient torque is applied to the hub 210 in the second direction after the clutch members 230 initially engage with the smooth clutch contacting portion 240 of the outer sleeve assembly 228 and the smooth clutch contacting portion 252 of the inner sleeve assembly 232. Thus, in some examples, the clutch members 230 are rotated into the third orientation after the clutch members 230 are rotated into the second orientation.

In some examples, the clutch members 230 rotate from the second orientation to the third orientation in unison. In other examples, the clutch members 230 rotate between the second and third orientations out of unison. This can be accomplished by design, or by inherent design intolerances in manufacturing the hub 210.

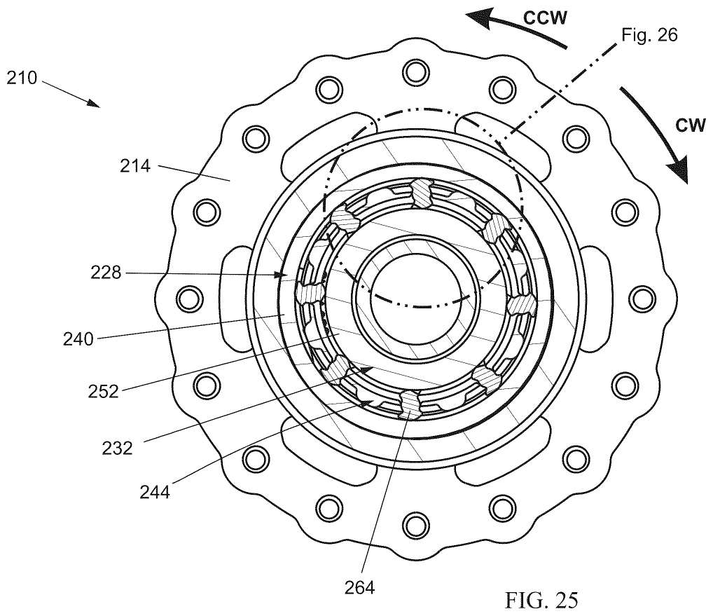

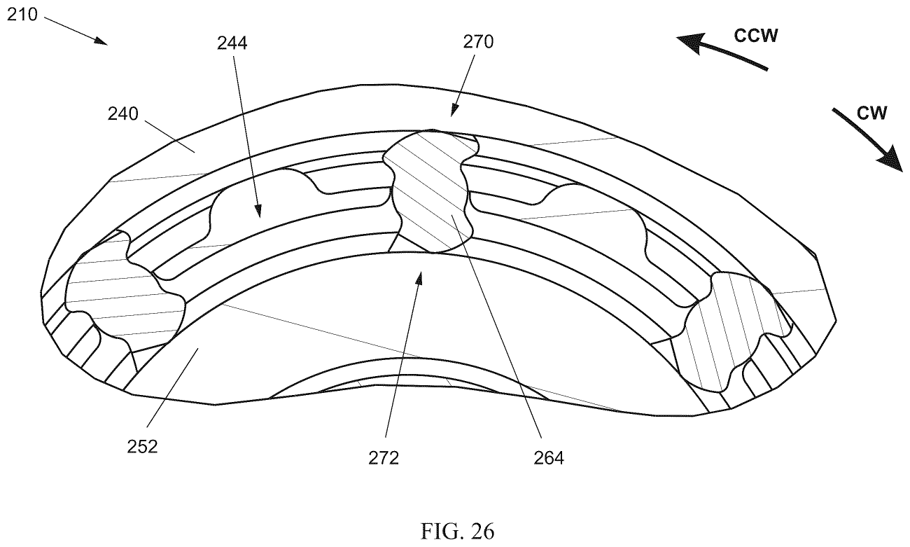

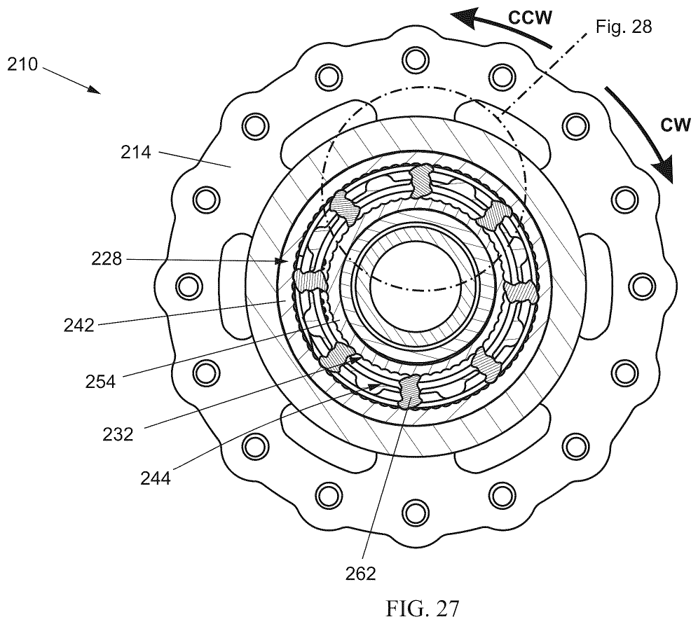

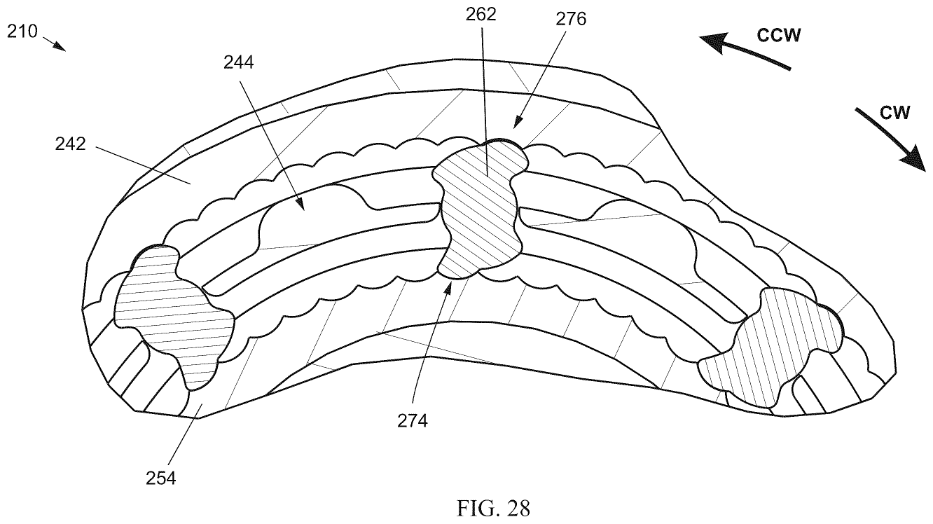

FIGS. 25-28 are cross sectional side views of an example hub 210 with the clutch members 230 arranged in the third orientation. FIGS. 25 and 27 are cross sectional side views of the entire hub 210. FIG. 26 is a zoomed in cross sectional side view of FIG. 25. FIG. 28 is a zoomed in cross sectional view of FIG. 27. FIGS. 25 and 26 depict the wedge portion 264 of the clutch members 230 (along line 17 in FIG. 6), while FIGS. 27 and 28 depict the interlocking portion 262 of the clutch members 230 (along line 19 in FIG. 6).

As seen in FIGS. 25 and 26, when placed in the third orientation, the clutch members 230 are rotated further so that the outer sleeve wedge portion 270 of the wedge portion 264 of the clutch members remains in contact with the smooth clutch contacting portion 240 of the outer sleeve assembly 228. The inner sleeve wedge portion 272 of the wedge portion 264 of the clutch members 230 also remains in contact with the smooth clutch contacting portion 252 of the inner sleeve assembly 232. Specifically, in some examples, a point between the slanted portion 273 and the rounded portion 271 of the outer sleeve wedge portion 270 engages with the smooth clutch contacting portion 240 of the outer sleeve assembly 228 and a point between the slanted portion 275 and the rounded portion 277 of the inner sleeve wedge portion 272 engages with the smooth clutch contacting portion 252 of the inner sleeve assembly 232. In some embodiments, the wedge portions 264 of the clutch members 230 remains engaged to and continues to function as a wedge between the inner sleeve assembly 232 and the outer sleeve assembly 228 while in the third orientation. This wedge continues to restrict the relative rotation of the hub shell 214 and the outer sleeve assembly 228 in the second direction with respect to the inner sleeve assembly 232. In some embodiments, if the hub shell 214 and the outer sleeve assembly 228 are rotated back in a first direction with respect to the inner sleeve assembly 232, the clutch members 230 are rotated back through the second orientation and back to the first orientation to permit the rotation in the first direction.

As seen in FIGS. 27 and 28, when placed in the third orientation, the clutch members 230 are rotated so that the outer sleeve interlocking portion 276 of the clutch members 230 fits within the features of the featured clutch contacting portion 242 of the outer sleeve assembly 228. Likewise, the inner sleeve interlocking portion 274 of the clutch members 230 fits within the featured clutch contacting portion 254 of the inner sleeve assembly 232. Specifically, in some examples, the first lobe 281 of the outer sleeve interlocking portion 276 fits within the features of the featured clutch contacting portion 242 of the outer sleeve assembly 228 while the first lobe 285 of the inner sleeve interlocking portion 274 fits within the featured clutch contacting portion 254 of the inner sleeve assembly 232. In some examples, the features of the featured clutch contacting portion 242 of the outer sleeve assembly 228 and the features of the featured clutch contacting portion 254 of the inner sleeve assembly 232 are shaped to receive the first lobes 281, 285 of the clutch members 230. In some examples, when in the third orientation, the interlocking portion 262 of the clutch members 230 provides an enhanced engagement between the outer sleeve assembly 228, clutch members 230 and the inner sleeve assembly 232 to further restrict the rotation of the hub shell 214 and the outer sleeve assembly 228 in the second direction with respect to the inner sleeve assembly 232.

Therefore, as described above, in some examples, the interlocking portion 626 of the clutch members 230 is engaged sequentially after the wedge portion 264 is engaged.

The angle of rotation between the first orientation and the third orientation is greater than the angle of rotation between the second orientation and the third orientation. In some examples, the angles of rotation of the clutch members 230 when rotating between the first orientation to the second orientation, and between the second orientation and the third rotation, may vary. In some examples, the angle of rotation between the first orientation to the second orientation is greater than the angle of rotation between the second orientation and the third orientation. In other examples, the angle of rotation between the first orientation to the second orientation is less than the angle of rotation between the second orientation and the third orientation. In other examples the angle of rotation between the first orientation to the second orientation is about the same as the angle of rotation between the second orientation and the third orientation.

As noted above with respect to FIGS. 8-9 and 11, in some examples, the inner sleeve assembly 232 and the outer sleeve assembly 228 may be constructed such that the inner sleeve assembly 232 and/or the outer sleeve assembly 228 includes only one of the smooth clutch contacting portion 252, 240 or the featured clutch contacting portion 254, 242. Likewise, the clutch members 230 may be constructed in an analogous manner. In such embodiments, an interlocking engagement with the clutch members 230 may occur on only one of the inner sleeve assembly 232 or the outer sleeve assembly 228. In some embodiments, such as the alternative embodiment described above with reference to FIG. 11, the clutch members 230 may be rotated into the second orientation in which the outer sleeve wedge portion 270 and the inner sleeve wedge portion 272 contact the smooth clutch contacting portion 240 on the outer sleeve assembly 228 and the smooth clutch contacting portion 252 on the inner sleeve assembly 232, respectively. However, once a sufficient amount of torque is applied to rotate the clutch members 230 into the third orientation, the inner sleeve wedge portion 272 remains in contact with the smooth clutch contacting portion 252 on the inner sleeve assembly 232, while the outer sleeve interlocking portion 276 contacts the featured clutch contacting portion 242 on the outer sleeve assembly 228. Because the clutch members 230 do not include an inner sleeve interlocking portion 274 in this alternative embodiment, the interlocking engagement occurs solely between the outer sleeve interlocking portion 276 and the featured clutch contacting portion 242 on the outer sleeve assembly 228. In other examples, however, the clutch members 230 outer sleeve assembly 228, and inner sleeve assembly 232 could be arranged such that the interlocking engagement occurs solely between the inner sleeve interlocking portion 274 and the featured clutch contacting portion 54 on the inner sleeve assembly 232.

In some examples, the engagement between the clutch members 230 and the outer sleeve assembly 228 and/or the inner sleeve assembly 232 provided by the interlocking portion 262 permits the hub 210 to withstand greater torques that might otherwise result in slippage between the wedge portion 264 of the clutch members 230 and the smooth clutch contacting portion 240 of the outer sleeve assembly 228 and the smooth clutch contacting portion 252 of the inner sleeve assembly 232. Therefore, providing the clutch members 230 with the interlocking portion 262, along with the featured clutch contacting portion 242 on the outer sleeve assembly 228 and featured clutch contacting portion 254 on the inner sleeve assembly 232 may allow for the hub to withstand greater torques with the use of fewer clutch members 230. Because fewer clutch members 230 are needed, the hub 210 can be constructed to be lighter than a hub that only uses clutch members 230 with a wedge portion.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

1. A clutch comprising:
an inner rotatable member and an outer rotatable member configured to rotate about an axis of rotation, the inner rotatable member being positioned radially inside the outer rotatable member; and
a plurality of clutch members positioned radially between the inner rotatable member and the outer rotatable member, the clutch members being spaced circumferentially about the axis of rotation relative to one another, the clutch members each including a wedge portion and an interlock portion;
wherein when relative rotation between the inner rotatable member and the outer rotatable member is forced in a second rotational direction the clutch members move to an engaged state in which the clutch members prevent relative rotation between the inner rotatable member and the outer rotatable member causing the inner rotatable member and the outer rotatable member to rotate in unison with one another about the axis of rotation;
wherein when relative rotation between the inner rotatable member and the outer rotatable member is forced in a first rotational direction the clutch members move to a disengaged state in which the clutch members allow relative rotation between the inner rotatable member and the outer rotatable member; and
wherein engagement of the clutch members is sequenced such that the wedge portions engage prior to the interlock portions as the clutch members move from the disengaged state to the engaged state.

2. The clutch of claim 1, further comprising an inner wedge bearing surface and an outer wedge bearing surface between which the wedge portions jam when the clutch members move to the engaged state, the inner wedge bearing surface corresponding to the inner rotatable member and facing in an outward radial direction and the outer wedge bearing surface corresponding to the outer rotatable member and facing in an inward radial direction.

3. The clutch of claim 2, further comprising at least one set of gear teeth corresponding to at least one of the inner rotatable member and the outer rotatable member for interlocking with the interlock portions of the clutch members when the clutch members move to the engaged state.

4. The clutch of claim 3, further comprising at least one smooth contacting portion corresponding to at least one of the inner rotatable member and the outer rotatable member for contacting the wedge portions of the clutch members when the clutch members move into the engaged state.

5. The clutch of claim 1, wherein the wedge portions of the clutch members engage when the clutch members are rotated from a first orientation to a second orientation.

6. The clutch of claim 5, wherein the interlock portions of the clutch members engage when the clutch members are rotated from the second orientation to a third orientation.

7. The clutch of claim 6, wherein the angle of rotation between the first orientation and the third orientation is greater than the angle of rotation between the first orientation and the second orientation.

8. The clutch of claim 2, wherein the interlock portions engage after sufficient torque is applied to initiate relative rotation between the inner rotatable member and the outer rotatable member in the second rotational direction after the wedge portions are engaged.

9. The clutch of claim 8, wherein the relative rotation between the inner rotatable member and the outer rotatable member in the second rotational direction after the wedge portions are engaged is caused by slippage between the wedge portions and the inner wedge bearing surface and the outer wedge bearing surface.

10. The clutch of claim 1, wherein the wedge portion contacts at least one of the inner rotatable member and the outer rotatable member while the inner rotatable member and the outer rotatable member rotate in a first direction relative to each other.

11. The clutch of claim 10, wherein the interlock portion does not contact at least one of the inner rotatable member and the outer rotatable member while the inner rotatable member and the outer rotatable member rotate in the first direction relative to each other.

12. A clutch assembly comprising:
an inner rotatable member;
an outer rotatable member having a portion being concentric with the inner rotatable member; and
a plurality of clutch members including a wedge portion and an interlocking portion;
the plurality of clutch members being arranged between the inner rotatable member and the outer rotatable member;
the inner rotatable member and the outer rotatable member being freely rotatable when rotated with respect to one another in a first direction;
the inner rotatable member and the outer rotatable member being coupled to one another by the clutch members to restrict the rotation of the inner rotatable member and the outer rotatable member with respect to one another in a second direction;
the interlocking portion of the clutch members being configured to contact a featured clutch contacting portion on at least one of the inner rotatable member and the outer rotatable member; and
the wedge portion of the clutch members being configured to contact a smooth clutch contacting portion on at least one of the inner rotatable member and the outer rotatable member, the smooth clutch contacting portion being smooth relative to the featured clutch contacting portion.

13. The clutch assembly of claim 12, wherein the wedge portions of the clutch members engage with the smooth clutch contacting portion to restrict the rotation of the inner rotatable member and the outer rotatable member with respect to one another in the second direction.

14. The clutch assembly of claim 13, wherein the interlocking portions of the clutch members engage with the featured clutch contacting portion to restrict the rotation of the inner rotatable member and the outer rotatable member with respect to one another in the second direction.

15. The clutch assembly of claim 14, wherein the wedge portions and the interlocking portions engage sequentially.

16. The clutch assembly of claim 15, wherein the interlocking portions engage after first torque is applied to overcome the engagement of the wedge portion and initiate rotation of the of the inner rotatable member and the outer rotatable member with respect to one another in the second direction.

17. The clutch assembly of claim 16, wherein the engagement of the interlocking portions with the featured clutch contacting portion restricts the rotation of the inner rotatable member and the outer rotatable member with respect to one another in the second direction when the first torque is applied.

18. The clutch assembly of claim 15, wherein the wedge portions of the clutch members contact the smooth clutch contacting portion while the inner rotatable member and the outer rotatable member are rotated with respect to one another in the first direction.

19. (canceled)

20. The clutch assembly of claim 15, wherein the clutch members rotate between a first orientation and a second orientation, wherein when placed into the second orientation, the wedge portions of the clutch members engage with the smooth clutch contacting portion to restrict the rotation of the inner rotatable member and the outer rotatable member with respect to one another in the second direction.

21. The clutch assembly of claim 20, wherein the clutch members rotate between the second orientation and a third orientation, wherein when placed into the third orientation, the interlocking portions of the clutch members engage with the featured clutch contacting portion to restrict the rotation of the inner rotatable member and the outer rotatable member with respect to one another in the second direction.

22-27. (canceled)
